(19) United States
(12) Patent Application Publication
(10) Pub. No.: US 2004/0203943 A1
(43) Pub. Date: Oct. 14, 2004

(54) Intelligent network application protocol communication between phone system switch and short message service center

(76) Inventors: Yigang Cai, Naperville, IL (US); Xu Chen, High Tech Park (CN); Hai Guang Mu, High Teck Park (CN)

Correspondence Address: PATTI & BRILL, ONE NORTH LASALLE STREET, 44TH FLOOR, CHICAGO, IL, 60602, US

(21) Appl. No.: 10/167,909

(22) Filed: Jun. 12, 2002

(51) Int. Cl. H04Q 7/20

(52) U.S. Cl. 455/466; 455/426.1

(57) ABSTRACT

An apparatus in one example comprises a phone system switch that employs intelligent network application protocol to communicate with a short message service center.

### TECHNICAL FIELD

The invention relates generally to communications and more particularly to text messaging in telecommunications.

### BACKGROUND

Personal handyphone systems (“PHSs”) are in operation in various parts of the world, including China and Japan. The personal handyphone systems allow subscribers to place and receive telephone calls while the subscribers are located in specified service areas. In the personal handyphone system, a mobile phone or handset communicates with a base station that is connected to additional mobile phones and the public switched telephone network (“PSTN”). The base station routes calls to and from the mobile phone. One shortcoming of the personal handyphone system is an inability of the mobile phone to send or receive text messages.

The intelligent network application protocol (“INAP”) allows communication of text and voice messages. In one implementation, the intelligent network application protocol is employed for communication between service switching points (“SSPs”) and service control points (“SCPs”). One shortcoming of the implementation is an inability to use the intelligent network application protocol for communication with the personal handyphone system.

A short message service (“SMS”) system handles routing of text messages between data terminals on one or more data networks. A subscriber on a network of the short message service system logs into a data terminal to send text messages to and receive text messages from other subscribers. Using integrated services digital network user part (“ISUP”), the short message service system sends text messages to and receives text messages from a subscriber in a mobile network such as a global system for mobile communications (“GSM”) or code division multiple access (“CDMA”) network. One shortcoming of the short message service system is an inability to use the integrated services digital network user part to send text messages to or receive text messages from a subscriber on the personal handyphone system. Another shortcoming of the short message service system is an inability to use the intelligent network application protocol to send text messages to or receive text messages from a subscriber on a telephone.

Thus, a need exists for enhanced employment of the intelligent network application protocol in text messaging. A need also exists for enhanced communication between personal handyphone system mobile phones and short message system data terminals. A further need exists for text communication with personal handyphone system mobile phones.

### SUMMARY

The invention in one embodiment encompasses an apparatus. The apparatus includes a phone system switch that employs intelligent network application protocol to communicate with a short message service center.

Another embodiment of the invention encompasses a method. There is communication directly between a phone system switch and a short message service center through employment of intelligent network application protocol.

A further embodiment of the invention encompasses an article. The article includes a computer-readable signal-bearing medium. The article includes means in the medium for communicating directly between a phone system switch and a short message service center through employment of intelligent network application protocol.

### DESCRIPTION OF THE DRAWINGS

Features of exemplary implementations of the invention will become apparent from the description, the claims, and the accompanying drawings in which:

FIG. 1 is a representation of one example of an apparatus that comprises a personal handyphone system coupled with a short message service system by an intelligent network application protocol link.

FIG. 2 is a representation of an exemplary call flow for a text message sent from the personal handyphone system and received by the short message service system of the apparatus of FIG. 1.

FIG. 3 is a representation of an exemplary call flow for a text message sent from the personal handyphone system and rejected by the short message service system of the apparatus of FIG. 1.

FIG. 4 is a representation of an exemplary call flow for a text message sent from the short message service system and received by the personal handyphone system of the apparatus of FIG. 1.

FIG. 5 is a representation of an exemplary call flow for a text message sent from the short message service system and, upon subscriber failure to answer, released by the personal handyphone system to be later resent from the short message service system of the apparatus of FIG. 1.

FIG. 6 is a representation of an exemplary call flow for a text message sent from the short message service system and, upon subscriber unavailability, released by the personal handyphone system to be later resent from the short message service system of the apparatus of FIG. 1.

FIG. 7 is a representation of an exemplary call flow for a text message sent from the short message service system with invalid location information to the personal handyphone system of the apparatus of FIG. 1.

### DETAILED DESCRIPTION

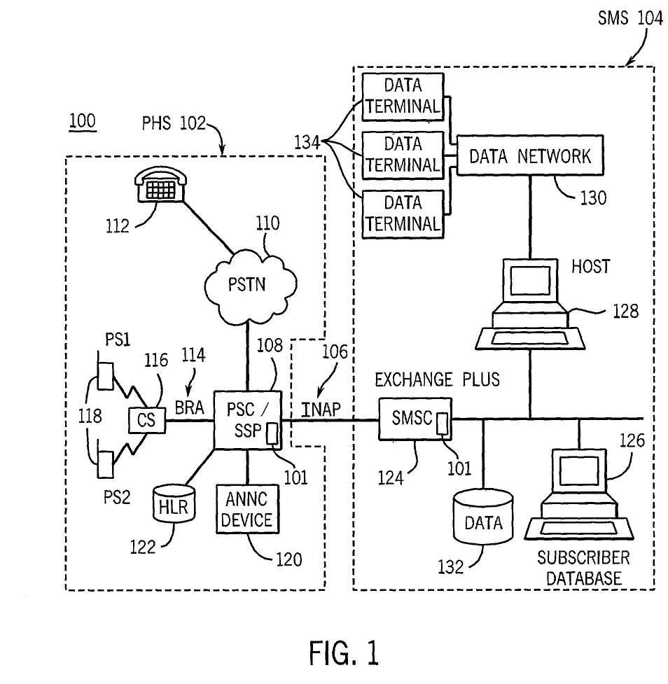

Turning to FIG. 1, an apparatus 100 in one example comprises a phone system switch that employs intelligent network application protocol to communicate with a short message service center. A portion of a component of the apparatus 100 in one example comprises all of the component. In another example, the portion of the component comprises a subportion of the component. The apparatus 100 in one example includes a plurality of components such as computer software and/or hardware components. A number of such components can be combined or divided in one example of the apparatus 100.

The apparatus 100 in one example employs at least one computer-readable signal-bearing medium. One example of a computer-readable signal-bearing medium for the apparatus 100 comprises an instance of a recordable data storage medium 101 such as one or more of a magnetic, electrical, optical, biological, and atomic data storage medium. In another example, a computer-readable signal-bearing medium for the apparatus 100 comprises a modulated carrier signal transmitted over a network comprising or coupled with the apparatus 100, for instance, one or more of a telephone network, a local area network (“LAN”), the internet, and a wireless network. An exemplary component of the apparatus 100 employs and/or comprises a set and/or series of computer instructions written in or implemented with any of a number of programming languages, as will be appreciated by those skilled in the art.

In one example, the apparatus 100 comprises a personal handyphone system (“PHS”) 102 coupled with a short message service (“SMS”) system 104 by an intelligent network application protocol (“INAP”) link 106. The personal handyphone system 102 comprises a personal handyphone system service switch center (“PSC”) 108, a public switched telephone network (“PSTN”) 110, one or more telephones 112, a basic rate access (“BRA”) integrated services digital network (“ISDN”) link 114, one or more cell stations (“CSs”) 116, one or more mobile phones 118, an announcement device 120, and a home location register (“HLR”) 122.

The personal handyphone system 102 allows subscribers to use the mobile phones 118 to place and receive telephone calls. In addition, the personal handyphone system 102 cooperates with the short message service system 104 and the intelligent network application protocol link 106 to allow subscribers to use the mobile phones 118 to send and receive text messages, as described herein. The personal handyphone system service switch center 108 handles all communications between subcomponents of the personal handyphone system 102. The personal handyphone system service switch center 108 couples the public switched telephone network 110, the cell station 116, the announcement device 120, and the home location register 122.

The personal handyphone system service switch center 108 in one example comprises a phone system switch. The phone system switch of the personal handyphone system service switch center 108 serves to connect heterogeneous networks. For example, the personal handyphone system service switch center 108 connects different types of voice networks and/or different types of data networks, including connection of voice networks with data networks. The personal handyphone system service switch center 108 serves to allow wireless communication to take place between wireless devices.

The personal handyphone system service switch center 108 employs the intelligent network application protocol link 106 for communicating with the short message service system 104. For example, the intelligent network application protocol link 106 directly connects the personal handyphone system 102 to the short message service system 104. The intelligent network application protocol involves a service-independent communications capability. For example, the personal handyphone system service switch center 108 and a short message service center (“SMSC”) 124 of the short message service system 104 comprise computer-controlled switches. So, an operator of the personal handyphone system service switch center 108 and the short message service center 124 may modify network characteristics by modifying software of the personal handyphone system service switch center 108 and the short message service center 124 controlling the switches. The personal handyphone system service switch center 108 employs software. For example, the personal handyphone system service switch center 108 employs service switching point (“SSP”) software for generating and interpreting the intelligent network application protocol messages.

The basic rate access integrated services digital network link 114 serves to couple the personal handyphone system service switch center 108 with the cell station 116. The cell station 116 employs electromagnetic waves to provide for wireless communication of mobile phones 118. For example, the cell station 116 comprises a base station. The cell station 116 communicates with the mobile phones 118 to transmit calls and messages through the personal handyphone system service switch center 108, as described herein.

The mobile phone 118 wirelessly communicates with the cell station 116. For example, the mobile phone 118 comprises one or more of a personal handset, a personal station (“PS”), an analog cellular phones, and a digital cellular phone. Subscribers employ one or more of buttons, icons, and touch-screen displays to communicates calls and text messages, as described herein.

The announcement device 120 serves to play announcements to subscribers as directed by the personal handyphone system service switch center 108. For example, the announcement device 120 provides a voice announcement that a called party is busy. The home location register 122 comprises a distributed database that is accessible by multiple personal handyphone system service switch centers 108. The home location register 122 stores all location and service information for the personal handyphone system subscribers.

The public switched telephone network 110 in one example comprises a network of landline telephones 112. A subscriber on the landline telephone 112 dials a number to place a call to subscriber on a mobile phone 118. The public switched telephone network 110 transmits the call to the personal handyphone system service switch center 108. The personal handyphone system service switch center 108 employs the dialed number to access the home location register 122 and locate the mobile subscriber. The personal handyphone system service switch center 108 routes the call over the basic rate access integrated services digital network link 114 to the cell station 116. The telephone call is broadcast as electromagnetic radiation to the mobile phone 118.

The personal handyphone system 102 cooperates with the short message service system 104 and the intelligent network application protocol link 106 to allow subscribers to use the mobile phones 118 to send text messages to and receive text messages from the data terminals 134. In addition, the personal handyphone system 102 cooperates with the short message service system 104 and the intelligent network application protocol link 106 to allow subscribers to use the data terminals 134 to send text messages to and receive text messages from the mobile phones 118 of the personal handyphone system 102, as described herein.

The short message service system 104 in one example comprises the short message service center 124, a subscriber database 126, a host terminal 128, a data network 130, a database 132, and a plurality of data terminals 134. The short message service center 124 serves as a control point of the short message service system 104. The subscriber database 126 comprises a distributed database that stores location and service information for subscribers. In one example, the subscriber database 126 contains information regarding where to send the text messages that arrive at the short message service center 124. For example, the subscriber database 126 serves to link subscriber names, mobile and landline telephone numbers, e-mail addresses, and internet protocol addresses of the data terminals 134 on the data network 130.

The data network 130 in one example comprises the internet. Subscribers to the short message service system 104 connect to the data network 130 through data terminals 134. For example, the data terminal 134 comprises a personal computer that is connectable to the data network 130. The short message service center 124 employs transmission control protocol/internet protocol (“TCP/IP”) to communicate with the data network 130.

An illustrative description of exemplary operation of the apparatus 100 is now presented, for explanatory purposes. A subscriber inputs a short text message into the mobile phone 118. The subscriber sends the short text message from the mobile phone 118. The mobile phone 118 transmits the wireless device text message as electromagnetic radiation to the cell station 116. The cell station 116 sends the wireless device text to the personal handyphone system service switch center 108 through the basic rate access integrated data services network link 114. The personal handyphone system service switch center 108 inserts the wireless device text message into an intelligent network application protocol operation message. The personal handyphone system service switch center 108 sends the intelligent network application protocol operation message over the intelligent network application protocol link 106 to the short message service system 104.

The short message service center 124 receives the intelligent network application protocol operation message from the intelligent network application protocol link 106. The short message service center 124 verifies that the text message adheres to a set of criteria. For example, the short message service center 124 performs a rule check to determine whether a subscriber associated with the text message qualifies for requested provisioning features. The short message service center 124, in one example, checks one or more criteria such as constraints on the subscriber number, mobile origination number, mobile termination number, billing issues, message type, time of message, message length, and character types, fonts, and styles. The short message service center 124 converts the validated wireless device text message into a message appropriate for forwarding to the data network 130. For example, the short message service center 124 converts the wireless device text message into a data terminal text message. The short message service center 124 in one example converts the text between character sets such as Unicode, American Standard Code for Information Interchange (“ASCII”), and foreign language character sets.

The short message service center 124 accesses the subscriber database 126 to look up the subscriber identified as the intended recipient of the text message from the personal handyphone system service switch center 108. Where the intended recipient is on the short message service system 104, the short message service center 124 sends the text message to the host terminal 128. The host terminal 128 adds internet protocol addressing to the message and forwards the message to the data network 130. The recipient subscriber employs the data terminal 134 to view the message on the data network 130.

Where the intended recipient is on the personal handyphone system 102, the short message service center 124 prepares the text message for sending to the personal handyphone system service switch center 108. The short message service center 124 inserts the text message into an intelligent network application protocol operation message. The short message service center 124 sends the intelligent network application protocol operation message over the intelligent network application protocol link 106 to the personal handyphone system service switch center 108. The personal handyphone system service switch center 108 extracts the text message from the intelligent network application protocol operation message.

The personal handyphone system service switch center 108 prepares to forward the text message to the mobile phone 118 of the intended recipient subscriber. The personal handyphone system service switch center 108 accesses the home location register 122 to obtain the subscription information and current location information for the intended recipient subscriber. The personal handyphone system service switch center 108 sends the text message to the cell station 116. The cell station 116 sends the text message to the mobile phone 118.

In a further example, a subscriber on the data network 130 types on the data terminal 134 a short text message for a subscriber on the mobile phone 118. The subscriber on the data network 130 sends the short text message over the data network 130. The host terminal 128 receives the text message from the data network 130. The host terminal 128 sends the data terminal text message to the short message service center 124. The short message service center 124 looks up the intended recipient in the subscriber database 126. The short message service center 124 checks the data terminal text message against the set of criteria to verify that the data terminal text message is valid. The short message service center 124 converts the data terminal text message into a wireless device text message. For example, the short message service center 124 converts the validated data terminal text message into a message appropriate for forwarding to the personal handyphone system 102. The short message service center 124 in one example converts the text between character sets such as Unicode, American Standard Code for Information Interchange, and foreign language character sets. The short message service center 124 inserts the wireless device text message into an intelligent network application protocol operation message.

The personal handyphone system 102 receives the intelligent network application protocol operation message from the intelligent network application protocol link 106. The personal handyphone system switch 108 extracts the wireless device text message from the intelligent network application protocol operation. The personal handyphone system service switch center 108 accesses the home location register 122 to obtain the subscription information and current location information for the intended recipient subscriber. The personal handyphone system service switch center 108 sends the text message to the cell station 116. The cell station 116 sends the text message to the mobile phone 118.

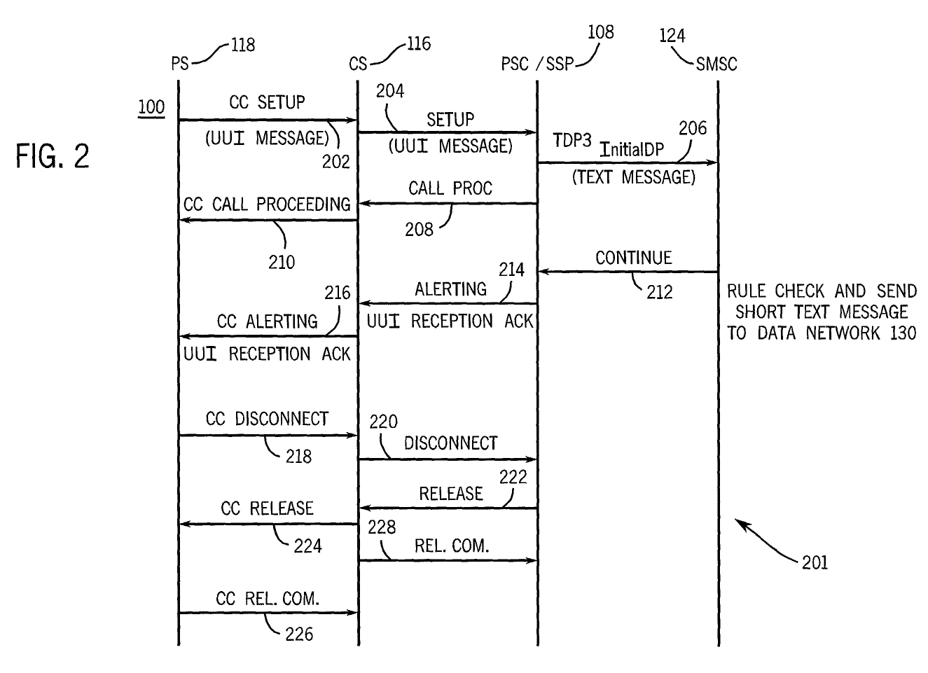

Turning to FIG. 2, a call flow 201 represents exemplary sending of a short message from a subscriber on the mobile phone 118 to a subscriber on the data terminal 134. The subscriber inputs the wireless device text message into the mobile phone 118. The mobile phone 118 sends a call control (“CC”) setup message 202. The call control setup message 202 comprises a user-to-user information (“UUI”) message. The mobile phone 118 sends the call control setup message 202 to the cell station 116. The cell station 116 sends a setup message 204 to the personal handyphone system service switch center 108. The personal handyphone system service switch center 108 extracts the wireless device text message from the setup message 204. The personal handyphone system service switch center 108 inserts the wireless device text message into an intelligent network application protocol call initiation operation message 206. For example, the call initiation operation message 206 comprises an intelligent network application protocol InitialDP operation message. The personal handyphone system service switch center 108 sends the call initiation operation message 206 across the intelligent network application protocol link 106 to the short message service system 124.

The short message service center 124 receives the intelligent network application protocol operation message 206 from the intelligent network application protocol link 106. The short message service center 124 validates the wireless device text message using the set of criteria. The short message service center 124 converts the wireless device text message into the data terminal text message. Also, the short message service center 124 accesses the database 132 to locate the destination e-mail address. The short message service center 124 employs the destination e-mail address to send the data terminal text message to the data network 130. The personal handyphone system service switch center 108 sends a call proceeding message 208 to the cell station 116. The cell station 116 sends a call control call proceeding message 210 to the mobile phone 118. The short message service center 124 sends a continue message 212 to the personal handyphone system service switch center 108. The continue message 212 is mapped into an alerting message 214 and sent back to the cell station 116. The cell station 116 sends a user-to-user information reception acknowledgement, call control alerting message 216 to the mobile phone 118.

The mobile phone 118 sends a call control disconnect message 218 to the cell station 116. The cell station 116 sends a disconnect message 220 to the personal handyphone system service switch center 108. The personal handyphone system service switch center 108 releases the mobile phone 118. Releasing the mobile phone is accomplished by sending a release message 222 to the cell station 116. The cell station 116 sends a call control release message 224 to the mobile phone 118. The mobile phone 118 sends a release complete acknowledgement message 226 to the cell station 116. The cell station 116 sends a release complete message 228 to the personal handyphone system service switch center 108.

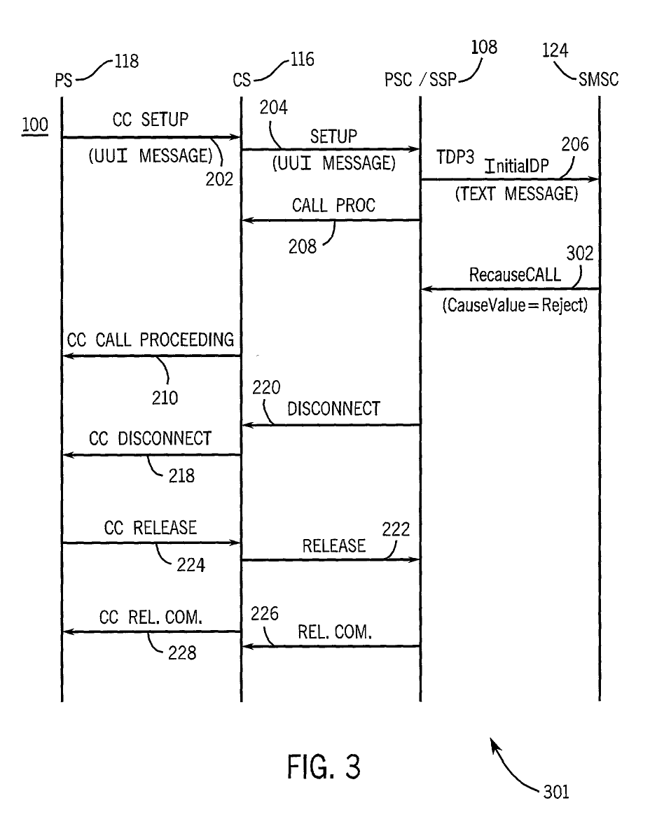

Turning to FIG. 3, a call flow 301 represents exemplary rejection at the short message service center 124 of a short message from a subscriber on the mobile phone 118 to a subscriber on the data terminal 134. The subscriber inputs the wireless device text message into the mobile phone 118. The mobile phone 118 inserts the wireless device text message into the call control setup message 202. The mobile phone 118 sends the call control setup message 202 to the cell station 116.

The cell station 116 sends the wireless device text message 204 to the personal handyphone system service switch center 108. The personal handyphone system service switch center 108 extracts the wireless device text message from the setup message 204. The personal handyphone system service switch center 108 inserts the wireless device text message into the intelligent network application protocol call initiation operation message 206. The personal handyphone system service switch center 108 sends the call initiation operation message 206 over the intelligent network application protocol link 106 to the short message service center 124.

The short message service center 124 receives the intelligent network application protocol operation message 206 from the intelligent network application protocol link 106. The short message service center 124 validates the wireless device text message using the set of criteria. The short message service center 124 converts the wireless device text message into a data terminal text message. The personal handyphone system service switch center 108 sends the call proceeding message 208 to the cell station 116. The cell station 116 sends the call control call proceeding message 210 to the mobile phone 118.

If the short message service center 124 rejects the wireless device text message during the rule check, the short message service center 124 sends a call rejection message 302 to the personal handyphone system service switch center 108. The personal handyphone system service switch center 108 maps the call rejection message 302 to the disconnect message 220 that is sent to the cell station 116. The cell station 116 sends the call control disconnect message 218 to the mobile phone 118. The mobile phone 118 sends the call control release message 224 to the cell station 116. The cell station 116 sends the release message 222 to the personal handyphone system service switch center 108. The personal handyphone system service switch center 108 acknowledges that the call has been released by sending the release complete acknowledgement message 226 to the cell station 116. The cell station 116 sends the call control release complete message 228 to the mobile phone 118.

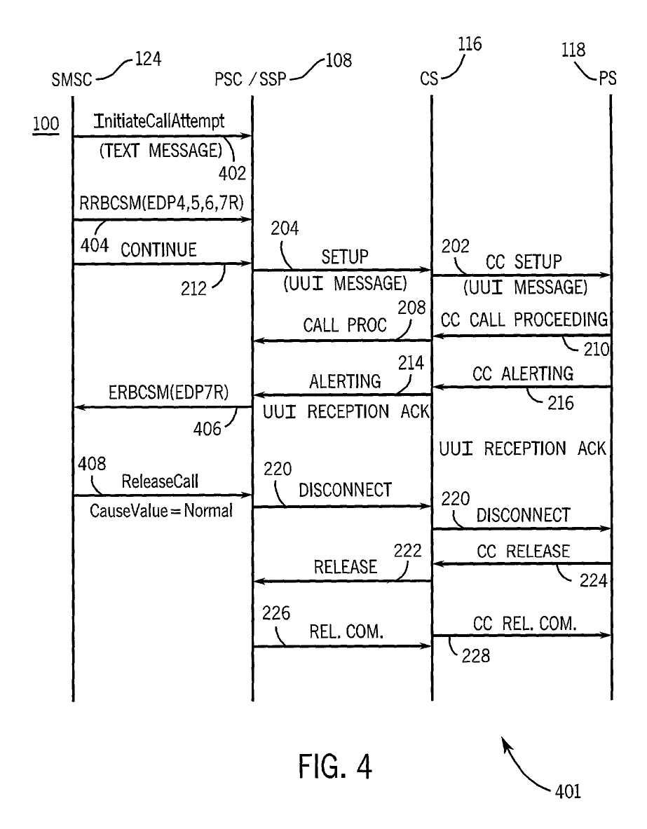

Turning to FIG. 4, a call flow 401 represents exemplary sending of a short message from a subscriber on the data terminal 134 to a subscriber on the mobile phone 118. The short message service center 124 validates the message using the set of criteria. The short message service center 124 converts the data terminal text message into a wireless device text message. The short message service center 124 inserts the wireless device text message into an initiate call attempt intelligent network application protocol operation message 402. The short message service center 124 sends the intelligent network application protocol operation message 402 through the intelligent network application protocol link 106. The personal handyphone system service switch center 108 receives the intelligent network application protocol operation message 402. The short message service center 124 sends an event request 404 to the personal handyphone system service switch center 108. The event request 404 serves to request a status report. The continue message 212 signals the start of the transmission of the short text message from the short message service center 124 to the personal handyphone system service switch center 108.

The personal handyphone system service switch center 108 extracts the wireless device text message from the intelligent network application protocol operation message 402 and places the data terminal text message into the setup message 204. The setup message 204 travels through the basic rate access integrated services digital network link 114. The cell station 116 employs the setup message 204 to send the call control setup message 202 to the mobile phone 118. The mobile phone 118 returns the call control call proceeding message 210 to the cell station 116. The cell station 116 sends the call proceeding message 208 to the personal handyphone system service switch center 108.

When the mobile phone 118 receives the text message, the mobile phone 118 sends the call control alerting message 216 to the cell station 116. The cell station 116 sends the alerting message 214 to the personal handyphone system service switch center 108. The personal handyphone system service switch center 108 decodes the alerting message 214 and finds that the message transmission is successful. The personal handyphone system service switch center 108 generates an event report 406 and sends the event report 406 to the short message service center 124.

Upon successful sending of the message and receipt of the acknowledgement, the short message service center 124 sends a release call intelligent network application protocol operation message 408 to the personal handyphone system service switch center 108. The release call intelligent network application protocol operation message 408 causes the personal handyphone system service switch center 108 to send the disconnect message 220 through the cell station 116 and to the mobile phone 118. The cell station 116 releases the call upon receipt of the call control release message 224 from the mobile phone 118. The cell station 116 sends the release message 222 to the personal handyphone system service switch center 108. The personal handyphone system service switch center 108 sends the release complete acknowledgement message 226 to the cell station 116. The cell station 116 sends the call control release complete message 228 to the mobile phone 118.

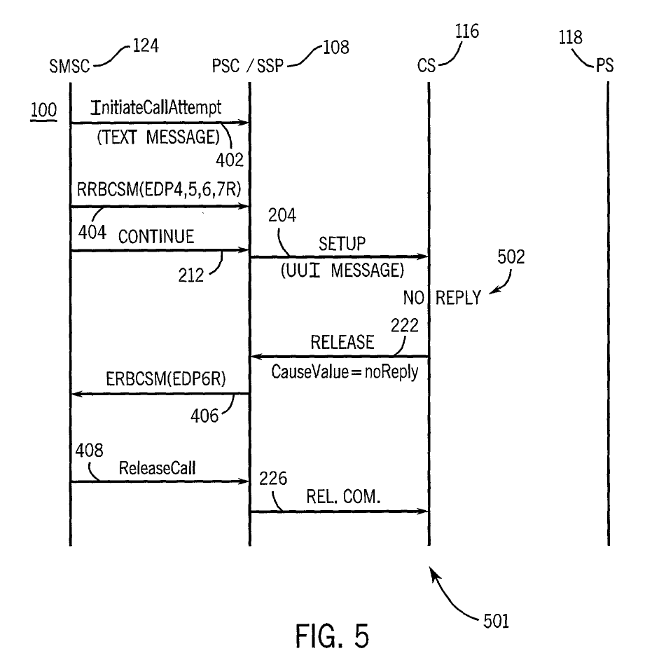

Turning to FIG. 5, a call flow 501 represents exemplary sending of a short text message from a subscriber on the data terminal 134 to a subscriber on the mobile phone 118 that does not reply. The short message service center 124 validates the message using the set of criteria. The short message service center 124 converts the data terminal text message to a wireless device text message. Also, the short message service center 124 generates the initiate call attempt intelligent network application protocol operation message 402. The short message service center 124 sends the initiate call attempt intelligent network application protocol operation message 402 to the personal handyphone system service switch center 108. In addition, the short message service center 124 sends the event request 404. The short message service center 124 sends the continue message 212.

From the intelligent network application protocol operation message 402, the personal handyphone system service switch center 108 extracts the wireless device text message. For example, the personal handyphone system service switch center 108 maps the wireless device text message from the intelligent network application protocol operation message 402 into the setup message 204. The personal handyphone system service switch center 108 transmits the setup message 204 to the cell station 116. The mobile phone 118 is unable to receive the message. For example, the mobile phone 118 is outside the subscriber area or is not in operation. This condition causes the mobile phone 118 to have no reply 502 to the message.

The cell station 116 sends the release message 222 to the personal handyphone system service switch center 108. The personal handyphone system service switch center 108 generates the event report 406 is generated due to the no reply 502. The personal handyphone system service switch center 108 sends the event report 406 to the short message service center 124. The short message service center 124 reschedules delivery of the message. The short message service center 124 sends a release call message 408 to the personal handyphone system service switch center 108. The personal handyphone system service switch center 108 sends the release complete acknowledgement message 226 to the cell station 116.

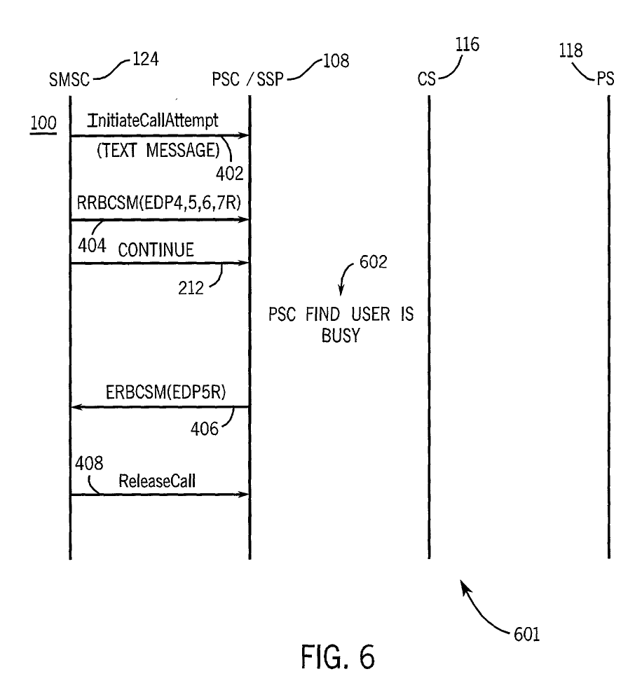

Turning to FIG. 6, a call flow 601 represents exemplary sending of a short text message from a subscriber on the data terminal 134 to a subscriber on the mobile phone 118 that is busy. The short message service center 124 validates the message using the set of criteria. The short message service center 124 converts the data terminal text message into a wireless device text message.

The short message service center 124 generates the initiate call attempt intelligent network application protocol operation message 402 containing the wireless device text message. The short message service center 124 sends the initiate call attempt intelligent network application protocol operation message 402 over the intelligent network application protocol link 106 to the personal handyphone system service switch center 108. The short message service center 124 also sends the event request 404 and the continue message 212 to the personal handyphone system service switch center 108. The personal handyphone system service switch center 108 attempts to deliver the wireless device text message, but the intended recipient is busy 602.

The personal handyphone system service switch center 108 then delivers the event report 406 to the short message service center 124 detailing why the wireless device text message has not been sent. In addition, the short message service center 124 reschedules delivery of the wireless device text message to the intended recipient. The short message service center 124 sends the release call message 408 to the personal handyphone system service switch center 108.

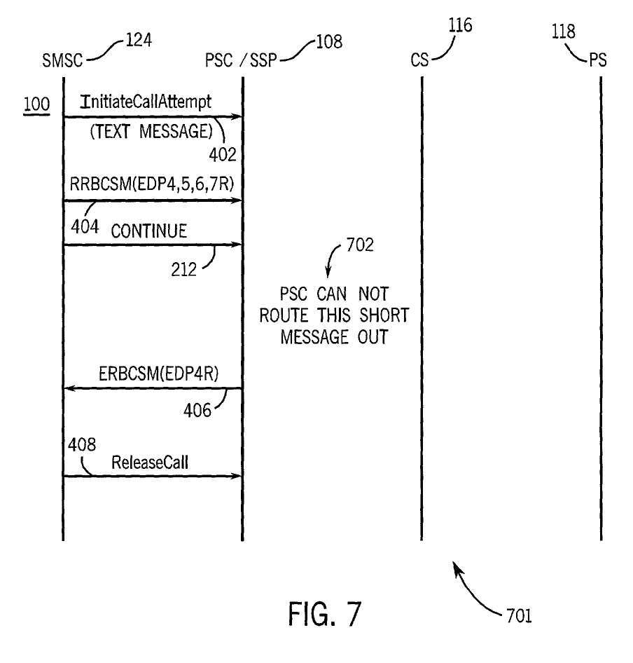

Turning to FIG. 7, a call flow 701 represents exemplary sending of a text message from a subscriber on the data terminal 134 to a subscriber on the mobile phone 118 in which the text message comprises invalid routing information. The short message service center 124 validates the message using the set of criteria. The short message service center 124 converts the data terminal text message to a wireless device text message.

The short message service center 124 generates the initiate call attempt intelligent network application protocol operation message 402 containing the wireless device text message. The short message service center 124 sends the initiate call attempt intelligent network application protocol operation message 402 over the intelligent network application protocol link 106 to the personal handyphone system service switch center 108. The short message service center 124 also sends the event request 404 and the continue message 212 to the personal handyphone system service switch center 108.

The personal handyphone system service switch center 108 attempts to deliver the wireless device text message. The personal handyphone system service switch center 108 cannot route wireless device text message. For example, the personal handyphone system service switch center 108 experiences a routing failure 702 for the wireless device text message. The personal handyphone system service switch center 108 delivers the event report 406 to the short message service center 124 detailing why the wireless device text message could not be sent. The short message service center 124 reschedules delivery of the data terminal text message. The short message service center 124 sends the release call message 408 to the personal handyphone system service switch center 108.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus, comprising:
a phone system switch that employs intelligent network application protocol to communicate with a short message service center.

2. The apparatus of claim 1, wherein the phone system switch employs the intelligent network application protocol to send a wireless device text message to the short message service center.

3. The apparatus of claim 2, wherein the phone system switch inserts the wireless device text message into an intelligent network application protocol operation message.

4. The apparatus of claim 3 in combination with the short message service center, wherein the short message service center extracts the wireless device text message from the intelligent network application protocol operation message.

5. The apparatus of claim 2, wherein the phone system switch receives the wireless device text message from a personal handyphone system mobile phone.

6. The apparatus of claim 5 in combination with the short message service center, wherein the personal handyphone system mobile phone comprises a first personal handyphone system mobile phone;
wherein the short message service center determines the wireless device text message is intended for a second personal handyphone system mobile phone, wherein the short message service center employs the intelligent network application protocol to send the wireless device text message to the phone system switch;
wherein the phone system switch sends the wireless device text message to the second personal handyphone system mobile phone.

7. The apparatus of claim 6, wherein the short message service center determines the wireless device text message satisfies one or more short message service system criteria, wherein the short message service center sends the wireless device text message to the phone system switch in an intelligent network application protocol operation message.

8. The apparatus of claim 2 in combination with the short message service center, wherein the short message service center determines the wireless device text message satisfies one or more short message service system criteria, wherein the short message service center converts the wireless device text message into a data terminal text message.

9. The apparatus of claim 8, wherein the short message service center sends the data terminal text message to a short message system data terminal coupled with the short message service center through a data network.

10. The apparatus of claim 1, wherein the phone system switch receives a wireless device text message in an intelligent network application protocol operation message.

11. The apparatus of claim 1 in combination with the short message service center, wherein the short message service center converts a data terminal text message into a wireless device text message, wherein the short message service center employs the intelligent network application protocol to send the wireless device text message to the phone system switch.

12. The apparatus of claim 11, wherein the short message service center determines the data terminal text message satisfies one or more short message service system criteria, wherein the short message service center inserts the wireless device text message into an intelligent network application protocol operation message, wherein the short message service center sends the intelligent network application protocol operation message to the phone system switch.

13. The apparatus of claim 12, wherein the phone system switch extracts the wireless device text message from the intelligent network application protocol operation message.

14. The apparatus of claim 12, wherein the phone system switch sends the wireless device text message to a personal handyphone system mobile phone.

15. The apparatus of claim 11, wherein the short message service center receives the data terminal text message from a short message system data terminal coupled with the short message service center through a data network.

16. A method, comprising the step of:
communicating directly between a phone system switch and a short message service center through employment of intelligent network application protocol.

17. The method of claim 16, wherein the step of communicating directly between the phone system switch and the short message service center through employment of the intelligent network application protocol comprises the steps of:
inserting a wireless device text message into an intelligent network application protocol operation message;
determining the wireless device text message satisfies one or more short message service system criteria; and
converting the wireless device text message into a data terminal text message.

18. The method of claim 16, wherein the step of communicating directly between the phone system switch and the short message service center through employment of the intelligent network application protocol comprises the steps of:
determining a data terminal text message satisfies one or more short message service system criteria;
converting the data terminal text message into a wireless device text message; and
inserting the wireless device text message into an intelligent network application protocol operation message.

19. The method of claim 16, wherein the step of communicating directly between the phone system switch and the short message service center through employment of the intelligent network application protocol comprises the steps of:
inserting a wireless device text message from a first personal handyphone system mobile phone into a first intelligent network application protocol operation message.
determining the wireless device text message satisfies one or more short message service system criteria;
determining the wireless device text message is intended for a second personal handyphone system mobile phone;
inserting the wireless device text message into a second intelligent network application protocol operation message;
extracting the wireless device text message from the second intelligent network application protocol operation message; and
sending the wireless device text message to the second personal handyphone system mobile phone.

20. An article, comprising:
a computer-readable signal-bearing medium; and
means in the medium for communicating directly between a phone system switch and a short message service center through employment of intelligent network application protocol.
